(19) United States
(12) Patent Application Publication
(10) Pub. No.: US 2024/0210912 A1
(43) Pub. Date: Jun. 27, 2024

(54) Monitoring at least one machine

(71) Applicant: SICK AG, Waldkirch (DE)

(72) Inventors: Pascal LIEGIBEL, Waldkirch (DE); Thomas NEUMANN, Waldkirch (DE); Heiko STEINKEMPER, Waldkirch (DE)

(21) Appl. No.: 18/544,955

(22) Filed: Dec. 19, 2023

(30) Foreign Application Priority Data
Dec. 22, 2022 (EP) 22216057.4

(51) Int. Cl. G05B 19/406

(52) U.S. Cl. CPC G05B 19/406; G05B 2219/50193

(57) ABSTRACT

A safety device for monitoring at least one machine is provided that has at least one sensor for generating sensor data on the machine and a processing unit for the sensor data that is connected at least indirectly to the sensor and to the machine, that is configured as a performance environment having at least one computing node that is configured to allow a plurality of logic units to run on the at least one computing node, wherein at least one logic unit is configured as a safety function unit for a safety directed evaluation of the sensor data and at least one logic unit is configured as a diagnostic unit for monitoring the at least one safety function unit, In this respect the at least one safety function unit is configured to transmit status reports and performance reports to the diagnostic unit and the diagnostic unit is configured to recognize a safety related malfunction of the safety device in a status monitoring using statuses from the status reports and in a performance monitoring using the performance routine from the performance reports.

The invention relates to a safety device and to a method for monitoring at least one machine.

Safety engineering deals with personal protection and with the avoidance of accidents with machines. A safety device of the category uses one or more sensors to monitor a machine or its environment and to switch it to a safe state in good time when there is impending danger. A typical conventional safety engineering solution monitors a protected field, that may not be entered by operators during the operation of the machine, by the at least one sensor, for instance by means of a laser scanner. If the sensor recognizes an unauthorized intrusion into the protected field, for instance a leg of an operator, it triggers an emergency stop of the machine. There are alternative protective concepts such as so-called speed and separation monitoring in which the distances and speeds of the detected objects in the environment are evaluated and a response is made in a hazardous situation.

Particular reliability is required in safety engineering and high safety demands therefore have to be satisfied, for example the standard EN13849 for safety of machinery and the machinery standard EN61496 for electrosensitive protective equipment (ESPE). Some typical measures for this purpose are a secure electronic evaluation by redundant, diverse electronics or different functional monitoring processes, for instance the monitoring of the contamination of optical components, including a front screen. Somewhat more generally, well-defined faults control measures have to be demonstrated so that possible safety-critical faults along the signal chain from the sensor via the evaluation up to the initiation of the safety engineering response can be avoided or controlled.

Due to the high demands on the hardware and software in safety engineering, primarily monolithic architectures have been used to date using specifically developed hardware that provides for redundancies and a functional monitoring by multi-channel capability and test possibilities. Proof of correct algorithms is accordingly documented, for instance in accordance with IEC TS 62998, IEC-61508-3, and the development process of the software is subject to permanent strict tests and checks. An example for this is a safety laser scanner such as is known, for example, for the first time from DE 43 40 756 A1 and whose main features are used in a widespread manner up to now. The entire evaluation function, including the time of flight measurement for the distance determination and the object detection in configured protected fields, is integrated there. The result is a fully evaluated binary safeguarding signal at a two-channel output (OSSD, output signal switching device) of the laser scanner that stops the machine in the event of an intrusion into the protected field. Even though this concept has proven itself, it remains inflexible since changes are practically only possible by a new development of a follow-up model of the laser scanner.

In some conventional safety applications, at least some of the evaluation is outsources from the sensor into a programmable controller (PLC, programmable logic controller). However, particular safety controllers are required for this purpose that themselves have multi-channel structures and the like for fault avoidance and fault detection. They are therefore expensive and provide comparatively little memory capacity and processing capacity that are, for example, completely overwhelmed by 3D image processing.

The use of standard controllers would admittedly be conceivable in principle while being embedded in the required functional monitoring processes, but this is hardly used in an industrial environment today since it requires more complex architectures and expert knowledge. In another respect, standard controllers or PLCs can only be programmed with certain languages with in part a very limited language area. Even relatively simple functional blocks require substantial development efforts and running time resources so that their implementation in a standard controller can hardly be realized with somewhat more complex applications, particularly under safety measures such as redundancies.

EP 3 709 106 A1 combines a safety controller with a standard controller in a safety system. More complex calculations remain with the standard controller and their results are validated by the safety controller. The safety controller, however, makes use of existing safe data of a safe sensor for this purpose, which restricts the possible application scenarios and additionally requires expert knowledge to acquire and thus suitably validate suitable safe data. In addition, the hardware structure is fixedly predefined and the application is specifically fixedly implemented thereon.

It would be desirable in a number of cases to combine the safety monitoring with automation work. Not only accidents are thus avoided, but the actual task of the machine is also likewise supported in an automated manner. Completely different systems and sensors have mostly been used for this purpose to date. This is inter alia due to the fact that a safety sensor for automation work is much too expensive and conversely the complexity of a safety sensor should not be overloaded with further functions. EP 2 053 538 B1 permits the definition of separate safety and automation regions for a 3D camera. This is, however, only a first step since admittedly the same sensor is still used for the two worlds of safety and automation, but these two tasks are then again clearly separated from one another spatially and at the implementation side. IEC 62998 permits the coexistence of safety and automation data, but does not make any specific implementation proposals as a standard.

There have long been very much more flexible architectures outside safety engineering. The monolithic approach has there long given way in a number of steps to more modern concepts. The earlier traditional deployment with fixed hardware on which an operating system coordinates the individual applications admittedly is still justified in stand-alone devices, but has no longer been satisfactory for a long time in a networked world. The basic idea in the further development was the inclusion of additional layers that are ever further abstracted from the specific hardware.

The so-called virtual machines where the additional layer is called a hypervisor or a virtual machine monitor are a first step. Such approaches have also been tentatively pursued in safety engineering in the meantime. EP 3 179 279 B1, for instance, provides a protected environment in a safety sensor to permit the user to allow his own program modules to run on the safety sensor. Such program modules are then, however, carefully separated from the safety functionality and do not contribute anything to it.

A further abstraction is based on so-called containers (container visualization, containerizing). A container is so-to-say a small virtual capsule for a software application that provides a complete environment for its running including memory areas, libraries, and the like. The associated abstracting layer or performance environment is called container runtime. The software application can thus be developed independently of the hardware, that can be practically any hardware, on which it later runs. Containers are frequently implemented with the aid of dockers.

In a modern IoT (internet of things, industrial internet of things) architecture, a plurality of containers having the most varied software applications are combined. These containers have to be suitably coordinated, which is known as orchestration in this connection, and for which a so-called orchestration layer is added as a further abstraction. Kubernetes has increasingly been established for container orchestration; in addition alternatives such as a Docker Swarm have become known as extensions of dockers as well as rkt, or LXC.

The use of such modern, abstracting architectures in safety engineering has previously failed due to high hurdles of safety standards and the correspondingly conservative approach in the application field of functional safety. Container technologies are definitely generally pursued in the industrial environment and there are for plans, for example in the automotive industry, for the use of Kubernetes architecture; and the German air force is also pursuing such approaches. However, none of this is directed to functional safety and so does not solve the problems named.

A high availability is admittedly also desired in a customary IoT world, but this form of fail-safety is by no means comparable to what the safety standards require. Edge or cloud applications have therefore been inconceivable for safety satisfying the standards for a safety engineer. It contradicts the widespread concept of providing reproducible conditions and of preparing for all the possibilities of a malfunction that are imaginable under these conditions. An extensive abstraction or visualization provides additional uncertainty that has previously appeared incompatible with the safety demands.

EP 4 040 034 A1 presents a safety device and a safety method for monitoring a machine in which the safety functionality can be abstracted from the underlying hardware using said container and orchestration technologies. Logic units are generated, resolved, or assigned to other hardware as required. This allows variable degrees of redundancy and a flexible mutual monitoring of logic units. Special logic units configured as diagnostic units are proposed for the testing and monitoring. EP 4 040 034 A1, however, does not explain how it is specifically possible with the aid of the concept of a diagnostic unit to actually locate safety related faults that occur in the total system.

It is therefore the object of the invention to further improve the just described flexible safety concept for practical implementation.

This object is satisfied by a safety device and by a method for monitoring at least one machine in accordance with the respective independent claim. The monitored machine or the machine to be safeguarded should initially be understood generally; it is, for example, a processing machine, a production line, a sorting station, a process unit, a robot, or a vehicle in a large number of variations such as rail-bound or not, guided or driverless, and the like. At least one sensor delivers sensor data to the machine, i.e. data on the machine itself, on what it interacts with, or on its environment. The sensor data are at least partially safety directed; additional non-safety directed sensor data for automation functions or comfort functions are conceivable. The sensors can, but do not have to, be safety sensors; the safety can be ensured only at a later position.

A processing unit acts as the performance environment. The processing unit is thus the structural element; the performance environment is its function. The processing unit is at least indirectly connected to the sensor and to the machine. It accordingly has access to the sensor data for its processing, possibly indirectly via interposed further units, and can communicate with the machine and can in particular influence it, preferably via a machine control of the machine. The processing unit or performance environment designates, as an umbrella term, the hardware and software with which a decision is made on the requirement and preferably also on the type of a safety directed response of the machine with reference to the sensor data.

The processing unit comprises at least one computing node. It is a digital computing device or a hardware node or a part thereof that provides processing and memory capacities for executing a software function block. However, not every computing node necessarily has to be a separate hardware module; a plurality of computing nodes can, for example, be implemented on the same device by using multiprocessors and conversely a computing node can also bundle different hardware resources.

A plurality of logic units run on the computing node or on one of the computing nodes in the operation of the safety device. A logic unit accordingly generally designates a software function block. In accordance with the invention, at least one logic unit is configured as a safety function unit that performs a safety related evaluation of the sensor data. The aim of the safety related evaluation is personal protection or accident avoidance in that it is determined with reference to the sensor data whether a hazard is impending or whether a safety related event has been recognized. This is, for example, the case on the detection of a person too close to the machine or in a protected field. One or more logic units can participate in the safety related evaluation. In the case of a safety directed event, a safety signal is preferably output to the machine to trigger a safety directed response there by which the machine is switched to a safe state that eliminates the hazard or at least reduces it to an acceptable level. At least one logic unit is furthermore configured as a diagnostic unit. The function of other logic units and in particular of the at least one safety function unit are thus monitored for faults.

The invention starts from the basic idea of carrying out a status and performance monitoring of the logic units by means of the diagnostic unit. For this purpose, the at least one safety function unit transmits status reports and performance reports to the diagnostic unit that are evaluated there. The state or status of the at least one safety function unit provides information on its operational readiness and on possible restrictions or faults in the at least one safety function unit. Performance reports relate to the performance of the safety function or of the service which the at least one safety function unit performs and a performance routine of the performed safety functions or services can be generated therefrom. Together, this allows a system diagnosis by which a safety related malfunction of the safety device can be recognized. In this respect, the diagnostic unit does not require either special knowledge as to how or with which algorithm a safety function unit works or what evaluation results it delivers even though both would be possible in a supplementary manner. In the event of a fault, the safe function of the safety device cannot be ensured, preferably with similar consequences of a safety related response of the machine as in the event of a hazard recognized by a safety function module. A single logic module configured as a diagnostic unit is sufficient for the system diagnosis, but it would also be conceivable to implement the status and performance monitoring in their respective own diagnostic units or to distribute the functionality over a plurality of logic modules.

The invention has the advantage that a highly flexible safety architecture is made possible that coordinates or orchestrates safety directed applications in an industrial environment (industrial internet of things, IIoT). In this respect, safety and automation can be tightly intertwined. Standard hardware is sufficient; no expensive dedicated safe hardware is required. The invention is largely independent of the specific hardware landscape as long as sufficient memory and computing resources are available overall. In addition, the robustness is substantially increased because logic units can be implemented on diverse hardware and can be displaced between computing nodes. The hardware landscape or part of the hardware landscape can be a cloud as an important conceivable application; the invention therefore combines the previously mutually foreign worlds of the cloud and safety engineering. Within the framework of cloud native concepts, there are existing open source frameworks and tools that also support widely designed applications, but do not yet provide any functional safety.

The approach in accordance with the invention is radically differently specified than conventionally in safety engineering. A fixed hardware structure has previously been predefined, typically separately developed for exactly this safety function, and the software functionality is developed for exactly this hardware structure, and is fixedly implemented and tested there. A subsequent change of the software deployment is precluded and this applies even more so by a change of the underlying hardware. Such modifications conventionally require at least one complex conversion by a safety engineer, as a rule a complete new development, A product of the typical conservative approach in industry and above all in safety engineering is that even firmware updates or software updates of sensors and controllers are in the most extreme case carried out in long cycles and typically not at all.

The terms safety or safe are used again and again in this description. They are respectively preferably to be understood in the sense of a safety standard. A safety standard, for example for machine safety, electrosensitive protective equipment, or the avoidance of accidents in personal protection is accordingly satisfied, or, worded a little differently again, safety levels defined by standards are observed, consequently faults up to a safety level defined by standard, consequently respective faults up to a safety level specified in the safety standard or specified in an analog manner thereto are managed. Some examples of such safety standards have been named in the introduction, where the safety levels are called, for example, protective classes or performance levels. The invention is not restricted to a specific one of these safety standards that may vary in their specific numbering and wording regionally and over time, but not in their basic principles for providing safety. The term safety is expanded a little below in some embodiments to include context-related or situative safety.

The implementation of the performance environment preferably takes place in Kubernetes. The performance environment is called a “control plane” there. A master coordinates the routines or the orchestration (orchestration layer). Computing nodes are called nodes in Kubernetes and they have at least one subnode or pod in which the logic units run in respective containers. Kubernetes is already aware of mechanisms by which a check is made whether a logic unit is still working. This check, however, does not satisfy any safety specific demands and is substantially restricted to obtain a sign of life from time to time and possibly to restart a container. There are no guarantees here as to when the fault occurs and has been remedied again.

The performance environment is preferably configured to produce and resolve logic units and to assign them to a computing node or to displace them between computing nodes. This is preferably not only done once, but also dynamically during operation and it very explicitly also relates to the safety related logic units that is the at least one safety function unit and/or the diagnostic unit. The link between the hardware and the evaluation is thus fluid while maintaining functional safety. Conventionally, all the safety functions are implemented fixedly and unchangeably on dedicated hardware. A change, where producible at all without conversion or a new development, would be considered as completely incompatible with the underlying safety concept. This already applies to a one-time implementation and in particular to dynamic changes to the runtime. In contrast, everything has previously always been done with a by all means large effort and a large number of complex individual measures that the safety function finds a well-defined and unchanged environment at the start and over the total operating time

The performance environment is preferably configured to change the resources assigned to a logic unit. It can assist the logic unit for a faster processing, but can also release resources for other logic units. Particular possibilities to provide more resources are the displacement of a logic unit to another computing node or the generation of another computing node or the generation of a further instance or copy of the logic unit, with a logic unit for the latter preferably being configured for a performance that can be parallelized.

The performance environment preferably keeps configuration information or a configuration file on the logic units stored. A record is kept on or specified on the logic units present with reference to the configuration information as to which logic units should be run in which time routine and with which resources and as to how they are possibly in relation with one another.

The configuration information is particularly preferably secured against manipulation by means of signatures or blockchain datasets. Such a manipulation can be intentional or unintentional; the configuration of the logic units should in any case not be changed in an unnoticed manner in a safety application.

The performance environment preferably has at least one master unit that communicates with the computing node and coordinates it. The master unit can also have a plurality of subunits for redundancy and/or for distributed responsibilities or can be assisted by node manager units of the computing nodes and can be implemented on a separate computing node or on a computing node together with logic units.

The at least one computing node preferably has a node manager unit for communication with other computing nodes and with the performance environment. This node management unit is responsible for the management and coordinates of the associated computing node, in particular the logic units of this computing node, and for the interaction with the other computing nodes and with the master unit. It can also take over work of the master unit in practically any desired deployment.

The at least one computing node preferably has at least one subnode and the logic units are associated with a subnode. The computing nodes are thus structured in themselves a further time to combine logic units in a subnode. This concept also follows Kubernetes in the form of pods.

The at least one logic unit is preferably implemented as a container. The logic units are then encapsulated or containerized and are runnable on practically any desired hardware. The otherwise customary relationship between the safety function and its implementation on fixed hardware is broken up so that the flexibility and process stability are very considerably increased. The performance environment coordinates or orchestrates the containers having the logic units located therein among one another. There are at least two abstraction layers, on the one hand a respective container layer (container runtime) and on the other hand an orchestration layer of the performance environment disposed thereabove.

The performance environment is preferably implemented on at least one sensor, a programmable logic controller, a machine controller, a processor device in a local network, an edge device and/or in a cloud. The underlying hardware landscape is in other works practically as desired, which is a very big advantage of the approach in accordance with the invention. The performance environment works abstractly with computing nodes; the underlying hardware can have a very heterogeneous composition. Edge or cloud architectures in particular become accessible to the safety engineering without having to dispense with the familiar evaluation hardware of (safe) sensors or controllers in so doing.

The performance environment is preferably configured to integrate and/or to preclude computing nodes. The hardware environment may thus vary; the performance environment is able to deal with this and to form new or adapted computing nodes. It is accordingly possible to connect new hardware or to replace hardware, in particular for replacement on a (partial) failure and for upgrading and for providing additional computing and memory resources. The logic units can continue to work on the computing nodes abstracted from the performance environment despite a possible, also brutally changed hardware configuration.

At least one logic unit is preferably configured as an automation unit that generates information relevant to the automation work and/or a control command for the machine from the sensor data, with the information and the control command not being safety directed. The performance environment thus assists a further type of logic unit that provides non-safety directed additional functions using the sensor data. With such automation work, it is not a question of personal protection or accident avoidance and no safety standards accordingly have to be satisfied to this extent. Typical automation work includes quality and running controls, object recognition for gripping, sorting, or for other processing steps, classifications, and the like. An automation unit also profits from this if the performance environment assigns it flexible resources and thereupon monitors whether it still performs its work and, for example, optionally starts the corresponding logic unit again, displaces it to a different computing node, or initiates a copy of the logic unit. It is then, however, a question of availability while avoiding downtimes and supporting proper routines that are absolutely very relevant to the operator of the machine, but have nothing to do with safety. It is conceivable to integrate an automation unit in the status and performance monitoring of the diagnosis unit since reliable automation functions can likewise provide added value even though a safety level is thereby observed that is possibly too high at this point.

The diagnostic unit is preferably configured to determine in a situation relative manner whether a malfunction is safety related. The statuses of the existing safety function units or of the performance routine can be differently evaluated in dependence on the current circumstances. An intrusion of a body part into a work zone of a robot, for example, exceptionally does not represent a hazard if it is simultaneously ensured that the robot instantaneously safely remains in a restricted coordinate zone that does not comprise the point of intrusion. It is even conceivable under such situation related conditions that safety function units and automation units dynamically change their roles.

The safety device preferably has a shutdown unit that is configured to set the machine into a safe state at the instruction of the diagnostic unit in the case of a safety related malfunction or at the instruction of a safety function unit on recognition of a hazard situation with reference to the evaluated sensor data. The shutdown unit or the shutdown service thus takes care of the machine actually being safeguarded when the diagnostic unit or a safety function requires it, preferably by a corresponding signal to the machine or its machine controller. Depending on the situation, the safe state is achieved, for example, by a slowing down, a special working mode of the machine, for example with a restricted freedom of movement or variety of movements, an evasion or a stopping. The shutdown unit can be implemented as a logic unit and can be integrated in a diagnosis. The shutdown unit preferably regularly receives a signal from the diagnostic unit that everything is in order and equally responds to an absence of this signal with a safeguarding measure such as in the case of an explicit safeguarding demand.

The performance environment preferably has a report system via which the at least one safety function unit transmits status reports and performance reports to the diagnostic unit. The report system is particularly preferably configured with two report channels to transmit status reports and performance reports beside one another. There are thus two report streams to be able to keep the status monitoring and the performance monitoring separated from one another.

The at least one safety function unit is preferably configured to regularly transmit a status report and/or to transmit a performance report on an event basis for a respective performance of its safety function. The status of the safety function unit is thus continuously monitored with a fine graininess that is ultimately specified by the desired safety level. Regularly can mean cyclically, but is a little softer. It is sufficient if the status is respectively known again at the latest after a predetermined time period, but the time intervals between two status reports can fluctuate within this framework. A performance report then respectively delivers new information if a performance had taken place in the meantime so that the exchange of performance reports can be implemented on an event basis. Since the safety function is based on sensor data and the sensors themselves frequently provide their data cyclically, the evaluation events can occur cyclically so that the event based sequence ultimately nevertheless becomes cyclic in this indirect manner.

The status report and/or the performance report preferably has/have a piece of transmitted information on the transmitting safety function unit, a time stamp, a sequence, and/or a checksum. The statuses and performances can thus be associated with the correct logic unit and can be categorized in time. The sequence puts the reports or their contents into an order. It can be ensured by a checksum or a comparable measure that the content of the report has been correctly transmitted.

The at least one safety function unit is preferably configured for a self-diagnosis in which it checks its own data, programs, processing results, and/or the agreement with a system time. The safety function unit can in particular determine its own status therefrom and can communicate it in a status report. A deviation from the system time would result in discrepancies with the time stamps in the reports and would thus possibly result in a defective system diagnosis. The self-diagnosis alone is not sufficient to ensure safety overall since the logic unit itself is not configured as safe; but a self-diagnosis represents a possible module of safety.

The diagnostic unit for the status monitoring is preferably configured to invoke a specified status expectation for the statuses of the at least one safety function unit, in particular to modify the status expectation with reference to previous statuses, work routines, and/or work results of the logic units, and to compare the status expectation with a current overall status derived from the statuses of the status reports. The diagnostic unit thus has the status expectation for a fault-free system, with this status expectation being able to be configured, otherwise specified, fixedly programmed, or provided in a memory. A status expectation can comprise obtaining a status report regularly at all from all existing safety function units or only certain statuses being reported that do not indicate a fault. The status expectation can be adapted in a situation related manner. Current status information is determined from the received status reports and is in particular combined into a total status to compare it with the status expectation. A deviation is an indication of a safety related malfunction. There can here still be tolerances with respect to certain safety functions and time tolerances. A deviation that cannot be explained by tolerances, the current situation, or another provided exception is preferably evaluated as a safety related malfunction, whereupon the machine is set into the safe state.

The status report preferably provides information on whether the safety function unit transmitting the status report exists, was able to initialize itself, whether all its required resources such as databases, code, libraries, computing resources, connection to the sensor are available, and/or whether it is operational. These are examples for the content of a status report or statuses that can be derived from the content. The status report can be only a summary O.K. that may even already be implied by the mere arrival of a report. The status report preferably also contains the above-named general information such as the sender, time stamp, and checksum.

The diagnostic unit for the performance monitoring is preferably configured to invoke a specified performance expectation for the performance routine of the at least one safety function unit, in particular to modify the performance expectation with reference to previous statuses, work routines, and/or work results of the logic units, and to compare the performance expectation with the current overall work performance routine derived from the performance reports. The diagnostic unit thus has the performance expectation of the time and logical sequence of the performances of that at least one safety function unit. This is compared with the actual performance sequence that results from the performance reports. Deviations are indications of a safety related malfunction. As already in the case of the status monitoring, not every deviation is necessarily a malfunction and not every malfunction is safety critical with the consequence of a safety related response of the machine. There are preferably tolerances in the comparison and, as discussed multiple times, possibly a situation related evaluation.

The diagnostic unit is preferably configured to take at least one of the following criteria into account on an evaluation of the comparison of the performance expectation with the performance routine derived from the performance reports: a performance order, the absence of a performance, an additional performance, a deviation of the performances from a time pattern, too short a performance duration, or too long a performance duration. The deviation from a time pattern can be understood as a particularly relevant special case of absence or adding of a performance. A number of these criteria do not necessarily result in a safety related monitoring gap. They are, however, an indication that the system is behaving differently than planned and if the deviation is not provided in the safety concept and is thus not safely controlled, the machine should be switched into the safe state as a precaution.

The performance report preferably has performance information on the respective last performance of the safety function, in particular with a start time and/or performance duration. The performance duration can naturally also be transmitted indirectly, for example by an end time. There is preferably the general information such as sender, time stamp of the report, and/or checksum. If a safety function unit performs a plurality of safety functions, a corresponding identification number of the safety function can be supplemented. Every safety function unit is, however, preferably only responsible for one safety function; if required for a further safety function, a further safety function unit can simply be generated. A performance report can also include performance results; for example, for targeted tests in which a check is made whether input data fed in as a test such as sensor data or emulated sensor data result in an expected performance result. The concept of status and performance monitoring is, however, preferably independent of specific content, which does not in turn preclude such tests additionally taking place, with also separate test diagnostic units and test reports being able to be used for this purpose.

The performance environment preferably has an aggregator that is logically arranged between the at least one safety function unit and the diagnostic unit and that is configured to receive the performance reports and to generate the performance routine from them with an order and/or duration of the performances of the safety functions of the at least one safety function unit. The aggregator thus takes over a partial task of the performance monitoring that can alternatively also be implemented in the diagnostic unit. The individual performance reports have already been combined into the performance routine after the aggregation. The aggregator preferably works in real time; it is here not just a question of providing data having indications of bottlenecks and the like for a subsequent manual optimization, but of a portion of the safety monitoring and thus ultimately accident avoidance.

The at least one sensor is preferably configured as an optoelectronic sensor, in particular a light barrier, light scanner, light grid, laser scanner, FMCW LIDAR, or camera, as an ultrasound sensor, inertia sensor, capacitive sensor, magnetic sensor, inductive sensor, UWB sensor, or as a process parameter sensor, in particular a temperature sensor, throughflow sensor, filling level sensor, or pressure sensor, with the safety device in particular having a plurality of the same or different sensors. These are some examples for sensors that can deliver relevant sensor data for a safety application. The specific selection of the sensor or sensors depends on the respective safety application. The sensors can already be configured as safety sensors. It is, however, explicitly alternatively provided in accordance with the invention to achieve the safety only subsequently by tests, additional sensor systems or (diverse) redundancy, or multi-channel ability, and the like and to combine safe and non-safe sensors of the same or different sensor principles with one another. A failed sensor would, for example, not deliver any sensor data; this would be reflected in the status and performance reports of the safety function unit responsible for the sensor and would thus be noticed by the diagnostic unit in the status and performance monitoring.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

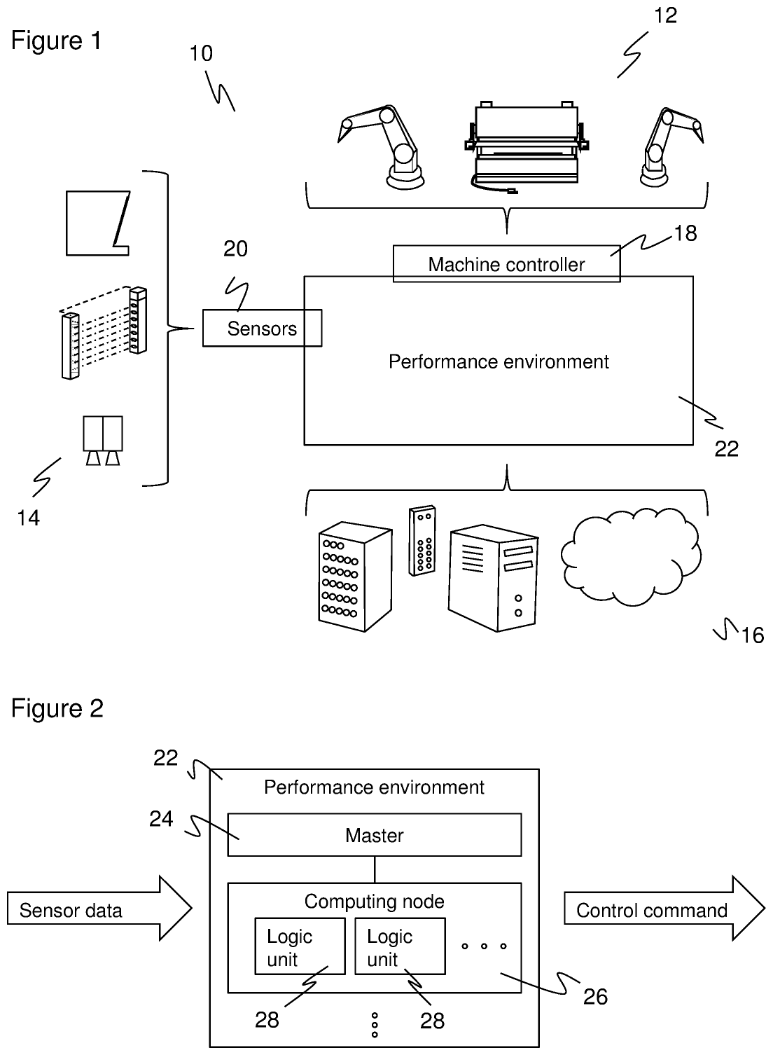

FIG. 1 an overview illustration of a safety device;

FIG. 2 a schematic representation of a performance environment of the safety device;

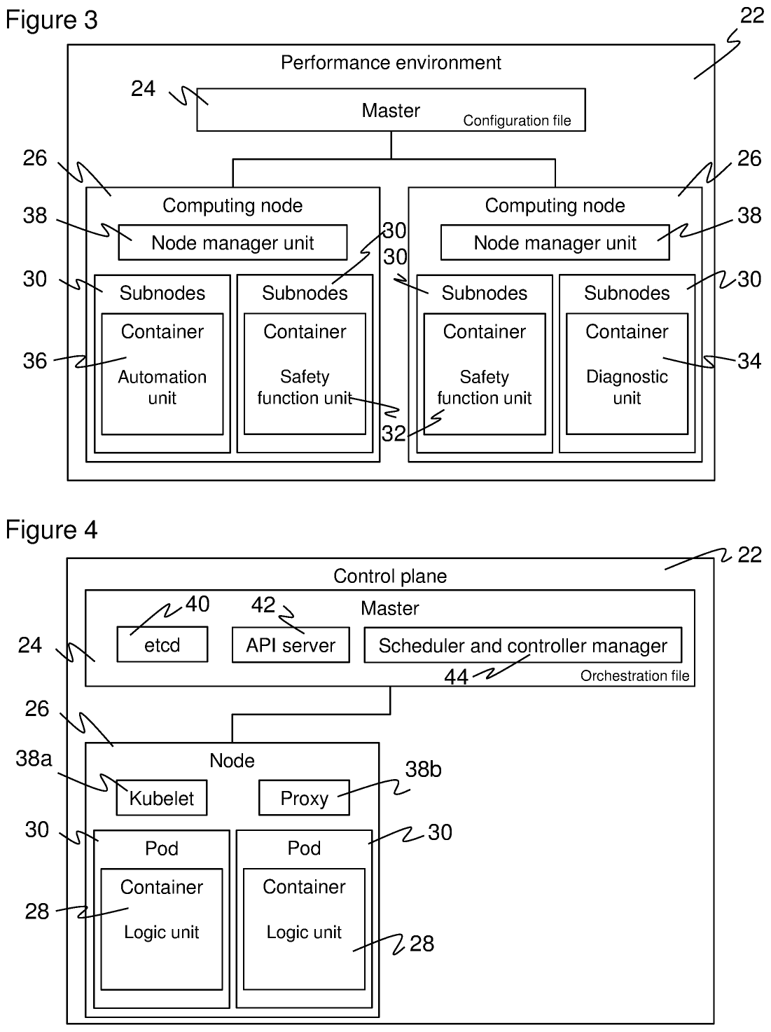

FIG. 3 a schematic representation of a performance environment by way of example using two computing nodes;

FIG. 4 a schematic representation of a performance environment similar to FIG. 3 in a special embodiment using Kubernetes;

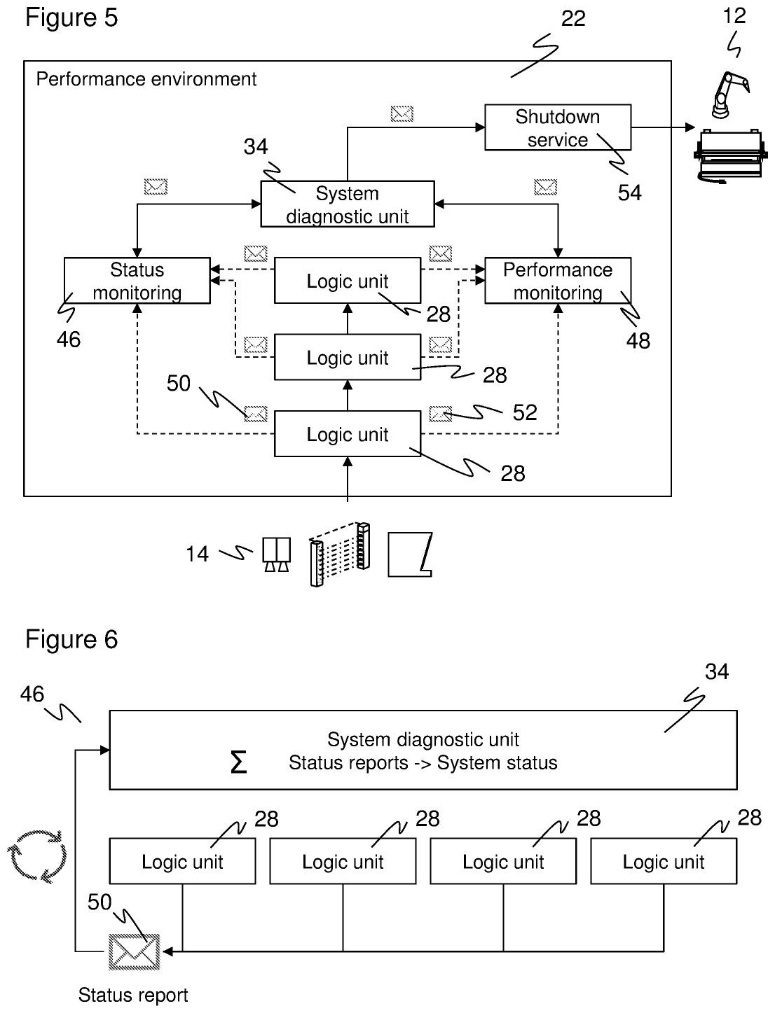

FIG. 5 a schematic representation of the double report flow with status and performance reports to a system diagnostic unit;

FIG. 6 a schematic representation of a status monitoring based on the status reports; and

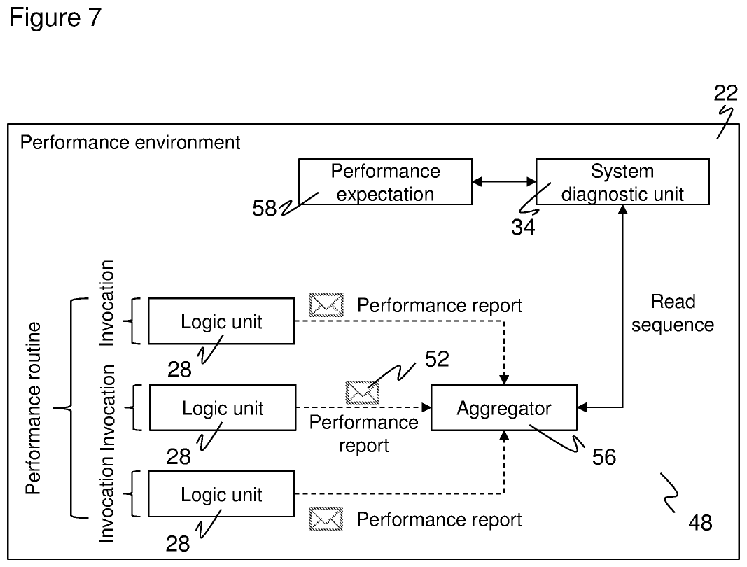

FIG. 7 a schematic representation of a performance monitoring based on the performance reports.

FIG. 1 shows an overview representation of a safety device 10. The terms safety and safe and unsafe are still to be understood such that corresponding components, transmission paths, and evaluations satisfy or do not satisfy the criteria of safety standards named in the introduction.

The safety device 10 can roughly be divided into three blocks having at least one machine 12 to be monitored, at least one sensor 14 for generating sensor data of the monitored machine 12, and at least one hardware component 16 with computing and memory resources for the control and evaluation functionality for evaluating the sensor data and triggering any safety directed response of the machine 12. The machine 12, sensor 14, and hardware component 16 are sometimes addressed in the singular and sometimes in the plural in the following, which should explicitly include the respective other embodiments with only one respective unit 12, 14, 16 or a plurality of such units 12, 14, 16.

Respective examples for the three blocks are shown at the margins. The preferably industrially used machine 12 is, for example, a processing machine, a production line, a sorting plant, a process plant, a robot, or a vehicle that can be rail-bound or not and is in particular driverless (AGC, automated guided cart; AGV, automated guided vehicle; AMR, autonomous mobile robot).

A laser scanner, a light grid, and a stereo camera as representatives of optoelectronic sensors are shown as exemplary sensors 14 which include further sensors such as light sensors, light barriers, FMVW LIDAR, or cameras having any 2D or 3D detection such as projection processes or time of flight processes. Some examples for sensors 14 that are still not exclusive are UWB sensors, ultrasound sensors, inertia sensors, capacitive, magnetic, or inductive sensors, or process parameter sensors such as temperature sensors, throughflow sensors, filling level sensors, or pressure sensors. These sensors 14 can be present in any desired number and can be combined with one another in any desired manner depending on the safety device 10.

Conceivable hardware components 16 include controllers (PLCs, programmable logic controllers) a processor in a local network, in particular an edge device, or a separate cloud or a cloud operated by others, and very generally any hardware that provides resources for digital data processing.

The three blocks are captured again in the interior of FIG. 1. The machine 12 is preferably connected to the safety device 10 via its machine controller 18, with the machine controller being a robot controller in the case of a robot, a vehicle controller in the case of a vehicle, a process controller in a process plant, and similar for other machines 12. The sensors 14 combined in the interior as a block 20 do not only generate sensor data, but also have an interface, not shown individually, to output the sensor data in a raw or (pre) processed form and as a rule have a separate control and evaluation unit, that is a separate hardware component for digital data processing.

A performance environment 22 is a summarizing term for a processing unit that inter alia performs the data processing of the sensor data to acquire control commands to the machine 13 or other safety directed and further information. The performance environment 22 is implemented on the hardware components 16 and will be explained in more detail in the following with reference to FIGS. 2 to 4. Which hardware the performance environment 22 is executed on is not fixed in accordance with the invention. The above list of possible hardware components names some examples that can be combined as desired. The performance environment 22 is furthermore intentionally drawn with an overlap to the machine controller 18 and to the block 20 of the sensors 14 since internal computing and memory resources of the sensors 14 and/or of the machine 12 can be also be used by the performance environment 22, again in any desired combination, including the possibility that there are no additional hardware components 16 at all outside the machine 12 and the sensors 14. It is assumed in the following that the hardware components 16 provide the processing and memory resources so that an inclusion of internal hardware of the machine 12 and/or sensors 14 is then also meant.

The safety device 10 and in particular the performance environment 22 now provides safety functions and diagnostic functions. A safety function accepts the flow of measurement and event information with the sensor data following one another in time and generates corresponding evaluation results in particular in the form of control signals for the machine 12. In addition, self-diagnosis information, diagnostic information of a sensor 4, or overview information can be acquired. The actual diagnostic functions by which the monitoring of a safety function is designated within the framework of this description, as will be explained in detail below with reference to FIGS. 5 to 7, must be distinguished from this. Unsafe automation functions are conceivable as a further option in addition to these safety related functions or safe automation functions.

The safety device 10 achieves a high availability and robustness with respect to unforeseen internal and external events in that safety functions are performed as services of the hardware components 16. The flexible composition of the hardware components 16 and preferably their networking in the local or non-local network or in a cloud enable a redundancy and a performance elasticity so that interruptions, disturbances, and demand peaks can be dealt with very robustly. The safety device 10 recognizes as soon as defects can no longer be intercepted and thus become safety directed and then initiates an appropriate response for the situation by which the machine 12 is moved into a safe state as required. For this purpose, the machine 12 is, for example, stopped, slowed down, it evades, or works in a non-hazardous mode. It must again be made clear that there are two classes of events that can trigger a safety directed response: on the one hand, an event that is classified as hazardous and that results from the sensor data, and, on the other hand, the revealing of a safety directed defect.

FIG. 2 shows a schematic representation of the performance environment 22. It is ultimately the object of the performance environment 22 to derive a control command from sensor data, in particular a safety signal that triggers a safety directed response of the machine 12. The performance environment 22 has a master 24 and at least one computing node 26. The hardware components 26 provide the required processing and memory capacity for the master 24 and computing nodes 26; the performance environment 22 can extend transparently over a plurality of hardware components 16. A computing node 26 is here to be understood abstractly or virtually; there is not necessarily a 1:1 relationship between a computing node 26 and a hardware components 16, but a hardware component 16 can rather provide a plurality of nodes 26 or, conversely, a computing node 26 can be deployed over a plurality of hardware components 16. The deployment applies analogously to the master 24.

A computing node 26 has one or more logic units 28. A logic unit 28 is a functional unit that is closed in itself, that accepts information, collates it, transforms it, recasts it, or generally processes it into new information and then makes it available to possible consumers as a control command or for further processing, in particular to further logic units 28 or to a machine controller 12. Three kinds of logic units 28 that have already been briefly addressed must primarily be distinguished within the framework of this description, namely safety function units, diagnostic units, and optionally automation units that do not contribute to the safety, but do enable the integration of other automation work in the total application.

The performance environment 22 activates the respective required logic units 28 and provides for their proper operation. For this purpose, it assigns the required resources on the available computing nodes 26 or hardware components 26 to the respective logic units 28 and monitors the activity and the resource requirement of all the logic units 28. The performance environment 22 preferably recognizes when a logic unit 28 is no longer active or when interruptions to the performance environment 22 or the logic unit 28 have occurred. It then attempts to reactivate the logic unit 28 and generates a new copy of the logic unit 28 if this is not possible to thus maintain proper operation. However, this is a mechanism that does not satisfy the demands of functional safety and only takes effect if the system diagnosis still to be explained with reference to FIGS. 5 to 7 has not previously uncovered a safety related fault or, for example, during an initialization phase or restart phase in which the machine 12 is anyway still at rest.

Interruptions can be foreseen or unforeseen. Exemplary causes are defects in the infrastructure, that is in the hardware components 16, their operating system, or the network connections; furthermore accidental incorrect operations or manipulations or the complete consumption of the resources of a hardware component 16. If a logic unit 28 cannot process all the required, in particular safety directed, information or at least cannot process it fast enough, the performance environment 22 can prepare additional copies of the respective logic unit 28 to thus further ensure the processing of the information. The performance environment 22 in this manner provides that the logic unit 28 produces its function at an expected quality and availability. In accordance with the remarks in the previous paragraph, such repair and amendment measures are also not any replacement for the system diagnosis still to be described.

FIG. 3 again shows a further advantageously fully differentiated embodiment of the performance environment 22 of the safety device 10. The master 24 forms the management and communication center. Configuration information or a configuration file on the logic units 28 present are stored therein so that the master 24 has the required knowledge of the configuration, in particular which logic units 28 there are and should be, on which computing nodes 26 they can be found, and in which time interval they received resources and are invoked. The configuration file is preferably secured via signatures against intentional and unintentional manipulations, for example via blockchain technologies. Safety engineering (safety) here advantageously joins forces with the data integrity ((cyber) security) since attacks are repulsed or at least recognized in this manner that could result in unforeseeable accident consequences.

The computing nodes 26 advantageously have their own sub-structure, with the now described units also being able only to be present in part. Initially, computing nodes 26 can again be divided into subnodes 30. The shown number of computing nodes 26 each having two subnodes 30 is purely exemplary; there can be as many computing nodes 26 each having any desired number of subnodes 30 as required, with the number of subnodes 30 being able to vary over the computing nodes 26. Logic units 28 are preferably only generated within the subnodes 30, not already on the level of computing nodes 26. Logic units 28 are preferably virtualized, that is containerized, within containers. Each subnode 30 therefore has one or more containers, with preferably a respective a logic unit 28. Instead of generic logic units 38, the three already addressed kinds of logic units 28 are shown in FIG. 3, namely two safety function units 32, a diagnostic unit 34, and an automation unit 36. The kind and number of the logic units 28 are only an example, with the system diagnosis still be explained with reference to FIGS. to 7 preferably managing with only one diagnostic unit 34. The association of logic units 38 with subnodes 30 and computing nodes 26 is wholly independent of the logical structure and cooperation of the logic units 28. No conclusion at all can therefore be drawn on the content cooperation from the arrangement of logic units 28 anyway only shown by way of example; any desired redistributions would be possible with fully the same functionality; the performance environment provides for this.

A node manager unit 38 of the computing node 26 coordinates its subnodes 30 and the logic units 28 assigned to this computing node 26. The node manager unit 38 furthermore communicates with the master 24 and with further computing nodes 26. The management work of the performance environment 22 can be deployed practically as desired on the master 24 and the node manager unit 38; 15 the master can therefore be considered as implemented in a deployed manner. It is, however, advantageous if the master looks after the global work of the performance environment 22 and each node management unit 38 looks after the local work of the respective computing node 26. The master 24 can nevertheless preferably be formed on a plurality of hardware components 16 in a deployed or redundant manner to increase its fail-safety.

The typical example for the safety function of a safety function unit 32 is the safety related evaluation of sensor data of the sensor 14. Typical examples here are inter alia distance monitoring (specifically speed and separation), passage monitoring, protected field monitoring, or collision avoidance with the aim of an appropriate safety directed response of the machine 12 in a hazardous case. This is the core task of safety engineering, with the most varied paths being possible of distinguishing between a normal situation and a hazardous one in dependence on the sensor 14 and the evaluation process. Suitable safety function units 32 can be programmed for every safety application or group of safety applications or can be selected from a pool of existing safety function units 32. If the work environment 22 generates a safety function module 32, this then by no way means that the safety function will thus be recreated. Use is rather made of corresponding libraries or dedicated finished programs in a known manner such as by means of data carriers, memories, or a network connection. It is conceivable that a safety function is assembled and/or suitably configured semiautomatically or automatically as from a kit.

A diagnostic unit 34 can be understood in the sense of EP 4 040 034 A1 named in the introduction and can act as a watchdog or can carry out tests and diagnoses of differing complexity. Safe algorithms and self-monitoring measures of a safety function unit 32 can thereby at least be partly replaced or complemented. For this purpose, the diagnostic unit 34 has expectations for the output of the safety function unit 32 at specific times, either in its regular operation or in response to specific artificial sensor information fed in as a test. A diagnostic unit 34 is used in accordance with the invention that does not test individual safety function units 32 or does not expect a specific evaluation result from them, even this is possible in a complementary manner, but that rather carries out a system diagnosis of the safety function modules 32 involved in the safeguarding of the machine 12, as will be explained below with reference to FIGS. 5 to 7.

An automation unit 36 is a logic unit 28 for non-safety related automation work that monitors sensors 14 and machines 12 or parts thereof, generally actuators, and that controls (partial) routines on the basis of this information or provides information thereon. An automation unit 36 is in principle treated by the performance environment like every logic unit 23 is thus preferably likewise containerized. Examples for automation work include a quality check, variant control, object recognition for gripping, sorting, or for other processing steps, classifications, and the like. The delineation from the safety directed logic units 28, that is from a safety function unit 32 or a diagnostic unit 34, comprises an automation unit 36 not contributing to accident prevention, i.e. to the safety directed application. A reliable working and a certain monitoring by the performance environment 22 is desired, but this serves an increase of the availability and thus of the productivity and quality, but not safety. This reliability can naturally also be established in that an automation unit 36 is monitored as carefully as a safety function unit 32 so that it is possible, but not absolutely necessary.

It becomes possible by the use of the performance environment 22 to deploy logic units 28 for a safety application in practically any desired manner over an environment, also a very heterogeneous environment, of the hardware components 26, including an edge network or a cloud. The performance environment 22 takes care of all the required resources and conditions of the logic units 28. It invokes the required logic units 28, ends or displaces them between the computing nodes 26 and the subnodes 30.

The architecture of the performance environment 22 additionally permits a seamless merging of safety and automation since safety directed function units 32, diagnostic units 34, and automation units 36 can be performed in the same environment and practically simultaneously and can be treated in the same manner. In the event of a conflict, the performance environment 22 preferably gives priority to the safety function units 32 unit and the diagnostic units 34, for instance in the event of scarce resources. Performance rules for the coexistence of relevant logic units 28 of the three different types can be taken into account in the configuration file.

FIG. 4 shows a schematic representation of a performance environment 22 in an embodiment using Kubernetes. The performance environment 22 is called a control plane here. FIG. 4 is based on FIG. 3, with a computing node 26 having been omitted for reasons of clarity and now generic logic units 38 being shown as representative for all three possible types. The master 24 has a sub-structure in Kubernetes. The (Kubernetes) master 24 is still not itself responsible for the design of containers or logic units 28, but rather takes care of the general routines or the orchestration (orchestration layer). The configuration file is accordingly called an orchestration file. A data etcd 40 for all the relevant data of the Kubernetes environment, an API server 24 as an interface to Kubernetes, and a schedule and controller manager 44 that carries out the actual orchestration are furthermore present.

The hardware present is divided into nodes as computing nodes 26. There are in turn one or more so-called pods as subnodes 30 in the nodes and the container having the actual micro-services are therein, in this case the logic units 28 together with the associated container runtime and thus all the libraries and dependences required for the logic unit 28 at the runtime. A node management unit 38 now divided into two performs the local management with a so-called Kubelet 38a and a proxy 38b. The Kubelet 38a is an agent that manages the separate pods and containers of the nodes. The proxy 38b in turn includes the network rules for the communication between the nodes and with the master.

Kubernetes is a preferred, but by no means the only implementation option for the performance environment 22. A Docker Swarm could be named as one further alternative among many. The docker itself is not a direct alternative, but rather a tool for producing containers and thus combinable with Kubernetes and a Docker Swarm that then orchestrate the containers.

FIG. 5 shows a further schematic representation of the performance environment 22 to illustrate a system diagnosis by a status monitoring and a performance monitoring. A system diagnostic unit 34 is responsible for this as a special embodiment of a diagnostic unit 34. Three logic units 28 that work in sequence to evaluate data of a sensor 14 are here purely by way of example for the monitoring. The invention is not restricted to this; there can be any desired number of logic units 28 in any desired mutual connection and with or without their own connection to a sensor 14. The logic units 28 are preferably safety function units 32. Further diagnostic units 34 can be provided that, for example, monitor or test specific safety function units in a dedicated manner supplementary to the system diagnosis. It is furthermore also possible to integrate automation units 36 in the system diagnosis even if a safe monitoring for the hazard avoidance or accident avoidance would per se be required therefor. It is not the specific design of the logic units 28 that is important in the following so that the generic logic units 28 are shown.

The system diagnosis unit 34 is responsible for a status monitoring 46 and a performance monitoring 48. A final assessment of the safe state of the total system can be derived therefrom. The status monitoring 46 will subsequently be explained in even more detail with reference to FIG. 6; the performance monitoring 48 with reference to FIG. 7. A single system diagnostic unit 34 is shown in FIG. 5 having its own blocks for the status monitoring 46 and performance monitoring 48. It above all serves the understanding of the concept; it is equally conceivable to understand the status monitoring 46 and the performance monitoring as part of the system diagnostic unit 34 or to alternatively, deploy the functionality in a different manner.

The logic units 28 communicate with the system diagnostic unit 34 over a report system or report transmission system. The report system is part of the performance environment 22 or is implemented as complementary thereto. There is a double report flow from the status reports or state reports 50 of the status monitoring 46 that provide information on the internal status of the sending logic unit 28 and performance reports 52 of the performance monitoring 52 that provide information on service demands or service runtimes of the sending logic units 28. The report system is consequently provided in double form or is configured with two report channels. Each report 50, 52 preferably comprises metadata that safeguard the report flow. These metadata, for example, comprise transmission information, a time stamp, sequence information, and/or a checksum on the report contents.

The system diagnosis unit 34 determines an overall status of the safety device 10 based on the obtained status reports 50 and correspondingly an overall statement on the processing of service demands or on a runtime routine of the safety device 10 from the obtained performance reports 52. Faults in the safety device 10 are uncovered by a comparison with associated expectations and an appropriate safety related response is initiated in the event of a fault.

Every irregularity does not immediately mean a safety related fault. Deviations can thus be tolerated for a certain time in dependence on the safety level or repair mechanisms are attempted to again move to a fault-free system status. However, the time and other framework in which only an observation can be performed is exactly specified by the safety concept here. There can furthermore be degrees of faults that require differently drastic safeguarding measures and evaluations of faults due to the situation. The latter results in a differentiated understanding of safety and safe that includes the current situation. The failure of a safety related component or the non-performance of a safety related function can still not necessarily mean an unsafe system state under certain requirements, i.e. due to the situation. A sensor 14 could, for example, have failed that monitors a collaboration zone with a robot while the robot definitely does not dwell in this zone, which can in turn be ensured by the robot's own safe coordinate bounding. Such situation related rules for the evaluation whether a safety related response has to take place must then, however, likewise be known to the system diagnostic unit 34 in a manner coordinated with the safety concept.

The safety related response of the machine 12 is preferably triggered by a shutdown service 54. It can be a further safety function unit 32 that can preferably be integrated in the system monitoring, contrary to the representation. The shutdown service 54 preferably works in an inverted manner, i.e. a positive signal is expected from the system diagnostic unit 34 and is forwarded to the machine 12 that the machine 12 may work. A failure of the system diagnostic unit 34 or of the shutdown service 54 is thus automatically contained.

Despite its name, the machine is not necessarily shut down by the shutdown service 54, this is only the most drastic measure. Depending on the fault, a safe status can already be achieved by a deceleration, a restriction of the speed and/or of the working space, or the like. This then has fewer effects on the productivity. The shutdown service 54 can also be required by one of the logic units 28 if a hazard situation has been recognized there by evaluating the sensor data. A corresponding arrow was omitted for reasons of clarity in FIG. 5.

FIG. 6 shows a schematic representation of the status monitoring 46 based on the status reports 50. Status reports 50 are preferably communicated continuously or regularly to the system diagnostic unit in the sensor that a status report 50 has to arrive from every monitored logic unit 28 at the latest after a fixed time of, for example, some milliseconds. A fixed cycle or time cycle is conceivable here, but not required, time fluctuations within the frame of the fixed duration are therefore possible.

The logic units 28 preferably carry out a self-diagnosis before the transmission of a status report 50. This is not necessarily the case in every embodiment; a status report 50 can be just a sign of life or the forwarding of internal statuses without a previous self-diagnosis or the self-diagnosis is carried out less often than status reports 50 are transmitted. The self-diagnosis, for example, checks the data and the program elements stored in its memory, the processing results, and the system time. The status reports 50 correspondingly contain information on the internal status of the logic unit 28 and provide information on whether the logic unit is able to perform its work correctly, for instance whether the logic unit 28 has all the required data available in a sufficient time. In addition, the status reports 50 preferably comprise the above-named metadata.

The system diagnostic unit 34 interprets the content of the status reports 50 and associates them with the respective logic units 28. The individual statuses of the logic units 28 are combined to form a total status of the safety device 10 from a safety point of view. The system diagnostic unit 34 has a predefined expectation as to which total state ensures the safety in which situation. If this comparison with the current total status shows that this expectation has not been met while possibly taking account of the already discussed tolerances and situation based adaptations, it is thus a safety related fault. A corresponding report is sent to the shutdown service 54 to set the machine 12 into a safe status appropriate for the fault.

FIG. 7 shows a schematic representation of the performance monitoring 48 based on the performance reports 52. The first logic unit 28 within a service generates an unambiguous program sequence characterization, in brief a sequence that all the involved logic units 28 of a service reference in their performance. The sequence is propagated to the directly following logic units 28 after ending the respective performance so that it can be related thereto on the preparation of its performance report 52. A performance report 52 comprises, preferably in addition to the above-named metadata, a start time and a duration of the respective performance. Further possible components of a performance report 52 are a unique description of what was carried out and of the sequence. Performance reports 52 are preferably sent on an event basis in each case after complete performance. Since sensor data that are cyclically available are frequently evaluated, an event-based report system can indirectly also be cyclic or regular in the above-defined sense.

An aggregator 56 collects the performance reports 52 and changes the performances into a logical and time arrangement or into a runtime routine with reference to the unique program sequence characterization. The runtime routine thus describes the actual runtimes. The system diagnostic unit 34, on the other hand, has access to a runtime expectation 57, i.e. an expected runtime routine. This runtime expectation 58 is a specification that a safety expert has typically fixed in connection with the safety concept but that can still be modified by the system diagnostic unit 34 in dependence on the embodiment. If the system diagnostic unit 34 should have no access to the runtime expectation 58, it is at least a safety related fault, at least after a time tolerance, with the consequence that the shutdown service 54 is prompted to safeguard the machine 12. The aggregator 56 and the runtime expectation 58 are shown separately and are preferably implemented in this manner, but can alternatively be understood as part of the system diagnostic unit 34.

The system diagnostic unit 34 now compares the runtime routine communicated by the aggregator 56 with the runtime expectation 58 as part of the performance monitoring 48 to recognize time and logical faults in the processing of a service demand. On irregularities, steps for stabilization can be initiated or the machine is safeguarded via the shutdown service 54 as soon as a fault can no longer be unambiguously controlled.

Some examples for checked aspects of the performance monitoring 48 are: there is no runtime to completely work through a service; an unexpected additional runtime was reported, either an unexpected multiple runtime of a logic unit 28 involved in the service or a runtime of a logic unit 28 not involved in the service; a runtime is too short or too long and indeed together with the quantification for the evaluation whether it is serious; the time elapsed between runtimes of individual runtimes of logic unit 28. Which of these irregularities are safety related, in which framework and in which situation they can still be tolerated, and which appropriate safeguarding measure is respectively initiated is stored in the runtime expectation 58 or in the system diagnostic unit 34.

1. A safety device for monitoring at least one machine, wherein the safety device has at least one sensor for generating sensor data on the machine and a processing unit for the sensor data that is connected at least indirectly to the sensor and to the machine, that is configured as a performance environment having at least one computing node and if further configured to allow a plurality of logic units to run on the at least one computing node, wherein at least one logic unit is configured as a safety function unit for a safety directed evaluation of the sensor data and at least one logic unit is configured as a diagnostic unit for monitoring the at least one safety function unit,
wherein the at least one safety function unit is configured to transmit status reports and performance reports to the diagnostic unit; and
wherein the diagnostic unit is configured to recognize a safety related malfunction of the safety device in a status monitoring using a status from the status reports and in a performance monitoring using a performance routine from the performance reports.

2. The safety device in accordance with claim 1,
wherein the diagnostic unit is configured to determine in a situation related manner whether a malfunction is safety related.

3. The safety device in accordance with claim 1,
that has a shutdown unit that is configured to set the machine into a safe state at the instruction of the diagnostic unit in the case of a safety related malfunction or at the instruction of a safety function unit on recognition of a hazard situation with reference to the evaluated sensor data.

4. The safety device in accordance with claim 1,
wherein the performance environment has a report system via which the at least one safety function unit transmits status reports and performance reports to the diagnostic unit.

5. The safety device in accordance with claim 4,
wherein the report system is formed with two report channels to transmit status reports and performance reports next to one another.

6. The safety device in accordance with claim 1,
wherein the at least one safety function unit is configured to regularly transmit a status report and/or to transmit a performance report on an event basis for a respective performance of its safety function.

7. The safety device in accordance with claim 1,
wherein at least one of the status report and/or the performance report has a piece of transmitted information on the transmitting safety function unit.

8. The safety device in accordance with claim 7,
wherein the piece of transmitted information on the transmitting safety function unit comprises at least one of a time stamp, a sequence, and a checksum.

9. The safety device in accordance with claim 1,
wherein the at least one safety function unit is configured for a self-diagnosis in which it checks its own data, programs, processing results, and/or the agreement with a system time.

10. The safety device in accordance with claim 1,
wherein the diagnostic unit for the status monitoring is configured to invoke a specified status expectation for the statuses of the at least one safety function unit.

11. The safety device in accordance with claim 10,
wherein the diagnostic unit for the status monitoring is configured to invoke a specified status expectation for the statuses of the at least one safety function unit to modify the status expectation with reference to previous statuses, work routines, and/or work results of the logic units, and to compare the status expectation with a current overall status derived from the statuses of the status reports.

12. The safety device in accordance with claim 1,
wherein the status report provides information on whether the safety function unit transmitting the status report exists, was able to initialize itself, all the required resources are available to it, and/or is operational.

13. The safety device in accordance with claim 1,
wherein the diagnostic unit for the performance monitoring is configured to invoke a specified performance expectation for the runtime routine of the at least one safety function unit.

14. The safety device in accordance with claim 13,
wherein the diagnostic unit for the performance monitoring is configured to invoke a specified performance expectation for the runtime routine of the at least one safety function unit to modify the performance expectation with reference to previous statuses, work routines, and/or work results of the logic units, and to compare the runtime expectation with the runtime routine derived from the performance reports.

15. The safety device in accordance with claim 13,
wherein the diagnostic unit is configured to take at least one of the following criteria into account on an evaluation of the comparison of the runtime expectation with the runtime routine derived from the performance reports: a runtime order, the absence of a performance, an additional performance, a deviation of the runtimes from a time pattern, too short a performance duration, or too long a performance duration.

16. The safety device in accordance with claim 1,
wherein the performance report has runtime information on the respective last performance of the safety function.

17. The safety device in accordance with claim 16,
wherein the performance report has runtime information on the respective last performance of the safety function, with a start time and/or performance duration.

18. The safety device in accordance with claim 1,
wherein the performance environment has an aggregator that is logically arranged between the at least one safety function unit and the diagnostic unit and that is configured to receive the performance reports and to generate the runtime routine from them with an order and/or duration of the performances of the safety functions of the at least one safety function unit.

19. The safety device in accordance with claim 1,
wherein the performance environment has an aggregator that is logically arranged between the at least one safety function unit and the diagnostic unit and that is configured to receive the performance reports and to generate the runtime routine from them with an order and/or duration of the performances of the safety functions of the at least one safety function unit in real time.

20. The safety device in accordance with claim 1,
wherein the at least one sensor is configured as an optoelectronic sensor or as a process parameter sensor.

21. The safety device in accordance with claim 20,
wherein the optoelectronic sensor is one of a light barrier, light sensor, light grid, laser scanner, FMCW LIDAR, or camera, as an ultrasound sensor, inertia sensor, capacitive sensor, magnetic sensor, inductive sensor, and an UWB sensor.

22. The safety device in accordance with claim 20,
wherein the process parameter sensor is one of a temperature sensor, throughflow sensor, filling level sensor, and a pressure sensor.

23. The safety device in accordance with claim 20,
wherein the safety device has a plurality of the same or different sensors.

24. A computer implemented method of monitoring at least one machine in which at least one sensor generates sensor data on the machine and a processing unit for the sensor data that is connected at least indirectly to the sensor and to the machine as a performance environment allows a plurality of logic units to run on at least one computing node, wherein at least one logic unit as a safety function unit evaluates the sensor data in a safety related manner and at least one logic unit as a diagnostic unit monitors the at least one safety function unit,
wherein the at least one safety function unit transmits status reports and performance reports to the diagnostic unit; and wherein the diagnostic unit recognizes a safety related malfunction in a status monitoring using statuses from the status reports and in a performance monitoring using the performance routine from the performance reports.
